(19) United States
(12) Patent Application Publication
(10) Pub. No.: US 2002/0079616 A1
(43) Pub. Date: Jun. 27, 2002

(54) Process and apparatus for producing plastic parts

(76) Inventor: Hermann Bartels, Muehlheim (DE)

Correspondence Address: Richard L. Schwaab, FOLEY & LARDNER, Washington Harbour, 3000 K Street, N.W., Suite 500, Washington, DC, 20007-5109, US

(21) Appl. No.: 09/961,406

(22) Filed: Sep. 25, 2001

(30) Foreign Application Priority Data
Sep. 25, 2000 (DE) 100 47 318.0

(51) Int. Cl. B28B 1/38

(52) U.S. Cl. 264/301; 264/310; 264/DIG. 60; 425/425

(57) ABSTRACT

Disclosed is a process for producing plastic parts, in which, with the aid of a heat-exchange medium, a mold is heated to the melting temperature of the plastic. As a result of rotation of a housing that carries the mold, the heat-exchange medium is brought repeatedly to the rear side of the mold and removed again. The heat-exchange medium used according to the invention is a thermally stable oil bath. The thermally stable oil is led through the feed line into the housing and contacts with the whole area of the rear of the mold. An inert gas blankets the oil in the housing. The oil is moved substantially turbulently as a result of the housing being rotated. The plastic powder is then applied to the mold in a manner known per se.

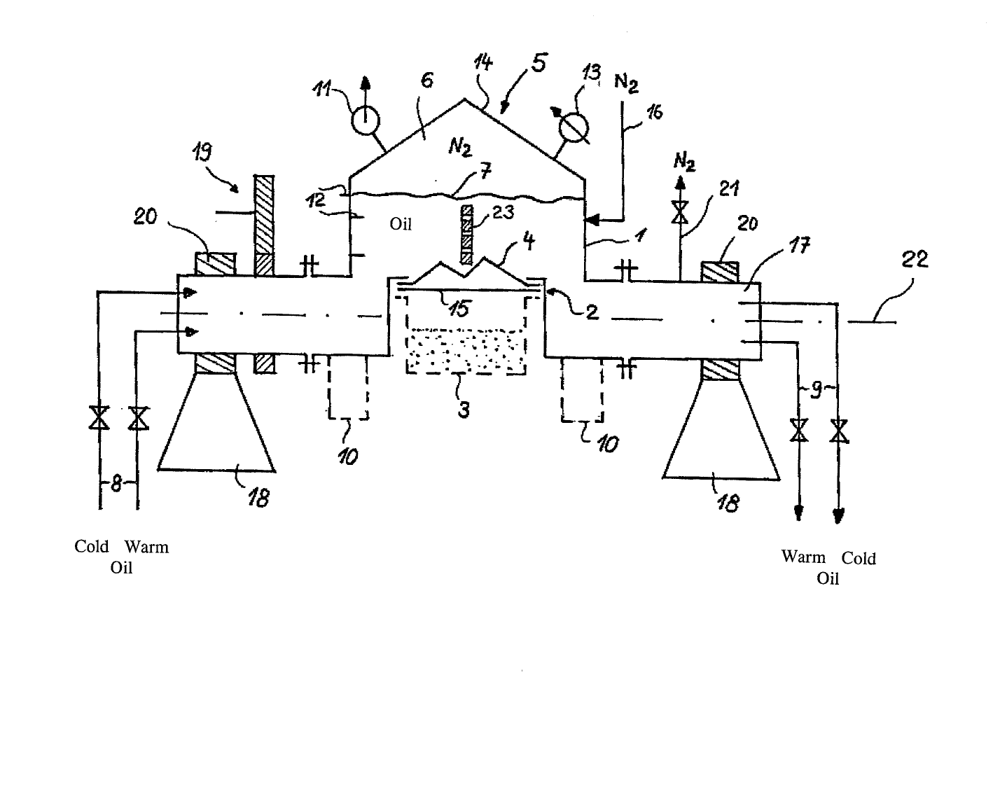

### BACKGROUND OF THE INVENTION

1. Field of the Invention

The present invention relates to a process and an apparatus for producing plastic parts, in particular skins or films. According to the process, a mold galvanically produced is heated to about the melting temperature of the plastic and then has plastic powder applied to it.

The powder layer melts on the mold and gells so that after the mold has been cooled down, a flexible skin (film) or, depending on the physical shape of the mold and the applied plastic, a molding can be lifted off the mold.

2. Description of Related Art

Such a process is described, for example, in DE 42 04 171 A1. In the process, the heating of the mold has to be carried out as homogeneously as possible, since even slight temperature differences can lead to production faults such as holes or nonuniform material thicknesses. DE 42 04 171 A1 therefore proposes to use a rotatable box, which is partly filled with sand. The sand (i) is heated up, (ii) is applied to the mold by rotation of the mold about the horizontal axis, (iii) is allowed to act for a short time, and (iv) is then removed from the mold by means of further rotation, so that the mold can be used again. This ensures, particularly at narrow grooves on the mold, that disproportionately cooled sand is mixed with the remainder again and heated up, to create homogeneous temperature conditions.

The disadvantage here is that the relatively fine-grained sand gets into seals and rotary bearings and impairs them. This is made more difficult by the fact that, the grains of sand become as fine as dust, as a result of rubbing on one another and on the walls during the frequent tilting of the sand box. This dust is released into the ambient air, after the box has been opened.

EP 0 502 378 B1 therefore proposes construction of the mold as a hollow body and heating the hollow body by streams of preheated oil. In this case, a large number of tubes are arranged on the mold, and oil fed in is drawn off again at a short distance from the feed point. Apart from the fact that the arrangement of very many pieces of tubing on the outer skin of the hollow body gives rise to extremely high costs, this does not satisfactorily solve the problem of nonuniform temperatures over the mold surface for at least two reasons. First, the feed line dissipates heat over its length. Second, stationary vortices form within the hollow mold body, which suppress the exchange of heat between the hollow body and the warm oil to a small extent, such that a lower heat transfer to the side of the mold to which plastic powder is to be applied occurs.

### SUMMARY OF THE INVENTION

Therefore, one object of the present invention is to provide a process and an apparatus (i) which ensure enhanced homogeneity of the temperature distribution over the mold surface, (ii) which are less complicated in terms of construction and (iii) which cause no emissions.

In accomplishing the objects of the invention, there has been provided according to one aspect of the invention a process for producing a plastic part, comprising rotating, about a horizontal axis, a housing defining a cavity therein and having a mold affixed in the cavity and a fluid heat exchange medium and a gas contained therein to alternately expose to and remove from substantially the entire surface area of a first side of the mold the heat exchange medium, as the orientation of the heat exchange medium in the housing changes during the rotating, to substantially turbulently mix the heat exchange medium, and to heat the mold to the melting temperature of a predetermined plastic material, and applying a powder of the predetermined plastic material to one side of the mold to form a plastic part.

In accordance with an additional aspect of the invention, there is provided an apparatus for producing a plastic part comprising a housing rotatable about a horizontal axis and defining a cavity therein; a mold operably linked to the housing and arranged in the cavity such that a first side of the mold faces the cavity and a second side of the mold faces away from the housing; a liquid heat exchange medium chamber formed within the housing cavity arranged above and in fluid communication with the first side of the mold; a removable cover for selectively covering the second side of the mold; a removable box suitable for holding plastic powder in communication with the second side of the mold, the box being interchangeable with the removable cover; a holder for holding the box in communication with the second side of the mold; and at least one inlet into the chamber for the heat exchange medium and at least one outlet from the chamber for the heat exchange medium.

In accordance with yet another aspect of the invention, there is provided a molding apparatus, comprising a base; a housing rotatably mounted on the base and defining a cavity therein; a drive operably linked to the housing for rotating the housing about a horizontal axis; a chamber formed within the housing cavity adapted for containing a liquid heat exchange medium; a mold mounted in the housing cavity such that a first side of the mold is in fluid communication with the chamber; a removable box adapted to be selectively placed in communication with a second side of the mold and adapted for containing a plastic powder; and a holder for removably holding the box on the housing.

Further objects, features and advantages of the present invention will become apparent from the detailed description of preferred embodiments that follows when considered together with the accompanying drawings.

### BRIEF DESCRIPTION OF THE DRAWING

The invention is explained in detail below with reference to the exemplary embodiments and with reference to the accompanying drawing, in which:

the FIGURE depicts an apparatus for producing plastic parts according to the invention.

### DETAILED DESCRIPTION OF PREFERRED EMBODIMENTS

The invention comprises a process and an apparatus for producing plastic parts. As part of the process, with the aid of a heat-exchange medium, a galvanically produced mold (hereinafter simply referred to as a mold) is heated to the melting temperature of a plastic and, as a result of rotation of a housing that carries the mold, the heat-exchange medium is brought repeatedly to the rear (backside) of the mold surface and removed again. The heat-exchange medium used according to the invention is a heat-resistant oil bath, which contacts the entire surface area of one side of the mold. An inert gas bubble blankets the oil in the housing. Here, as a result of the rotation of the housing, the oil is moved substantially turbulently. The plastic powder may be applied to the mold in a known manner.

A preferred process here, is as follows: oil flows at a temperature of, for example, 300° C. from an oil container via a valve-controlled feed line into the housing, which is oriented in an upright position. The oil container has a volume many times that of the rotary container. The oil level is monitored via a level monitor in a manner such that the mold is safely covered with oil. A gas-filled cavity exists above the oil. The housing is then rotated, so that the oil flows into the cavity and, as a result, is removed from the surface of the mold. The oil cooled on the mold is removed from all the regions of the mold and, at the same time, is mixed homogeneously with the warmer portion of the oil. Rotation is then carried out again, and the oil is brought back into contact with the mold.

Should the oil temperature drop below a specific temperature, the cooled oil can be drained off via a valve-controlled drain line and replaced by hot oil. This procedure is monitored via level monitors. The gas-filled cavity therefore has the function of accommodating the oil flowing away from the mold and (by means of suitable mixing elements and/or passageways) of homogenizing it thermally.

During the heating operation, the side of the mold facing away from the oil is closed by a cover, which reduces the emission of heat.

After the desired temperature has been reached, with the housing oriented at the top, the cover is removed, and a box filled with plastic powder, such as PVC or TPU, is coupled to the bottom of the mold. The further process steps can correspond to conventionally known processes.

After the powder has been completely fused thermally, the cooling process is initiated. With the housing at the top, the hot oil is drawn off partly or completely via a valve-controlled drain line. Then the housing is flooded with cold oil up to a defined level via a valve-controlled feed line to cool the mold. The further process preferably involves repeating the heating operation. After the cooling operation, the cooled skin is removed, and the heating operation is started again.

The apparatus according to the invention therefore preferably comprises a housing with a chamber at the top (when in an upright position) for the protective gas (inert gas), connections for the feed and drain line of hot and cold oil, a level monitor for the oil level, and a gas connection for the inert gas which covers the entire free surface of the thermal oil bath. Underneath the oil bath, there is a mold, which is sealed off with respect to the housing and has fixing means, located underneath it, for a cover or alternately a box for holding plastic powder. In addition to the mold, the housing may have collecting pockets for the inert gas that rises as the housing is rotated.

In addition, the inert gas bubble is advantageously connected to an over pressure valve, via which, if necessary, excess pressure produced by temperature variations can be dissipated.

Inert gas itself preferably blown in via a dedicated feed line. The inert gas preferably has a slight excess pressure when the oil is in the cold state, in order to ensure that no air can enter.

Finally, it is proposed to incorporate obstacles as turbulence generators into the housing. These can be, for example, deflection plates or screen plates, the latter advantageously being located at the height of the bath level or on the gas collecting pockets. This is of particular advantage when relatively low quantities of oil are to be used.

The present invention will be explained in more detail by using the appended FIGURE, which schematically depicts a preferred embodiment.

The apparatus comprises the housing 1 with an inert gas bubble 6 represented above. The housing 1 is filled with thermally stable oil, and the bath level 7 limits the volume of the inert gas bubble 6. In a side wall there are level sensors 12 to display and monitor the level of the oil. An over pressure valve 11 and a pressure measuring instrument 13 are depicted on the roof-like hood 14 of the housing.

In the oil bath, there is a holder 2 for the mold 4 and a cover 15 which thermally closes the mold at the bottom and which can be selectively replaced by the plastic powder-containing box 3. An inert gas line 16 leads into the housing. Tubular connecting pieces 17 which are connected to the housing 1 on both sides, rest on and are rotatably mounted on bases 18. The drive 19 serves the purpose of rotating the connecting pieces 17. Oil feed lines 8 and opposite drain lines 9 for cold and hot oil lead into and out of the connecting pieces 17 and can be designed in duplicate in order to produce mixed temperatures.

From the connecting piece located downstream, or at another point located downstream, inert gas entrained as small bubbles can be collected and drawn off or fed back (inert gas drain line). The volumes of the tubular connecting pieces are in this exemplary apparatus designed and arranged, such that when the apparatus is rotated in the bearings 20 of the bases 18, oil can be separated completely from the mold.

As a result of the rotation of the apparatus, the bath is set into turbulent motion, by means of which cooled components of the bath mix with the hotter ones, in order in this way to equalize the temperature of the bath and to repeatedly supply problem zones (areas of more rapid heat dissipation) of the mold with oil at the desired temperature.

In the housing 1, for example, below the level 7 of the bath, turbulence generators in the form of deflection plates or perforated plates 23 can be provided. Turbulence generators can of course also be provided in the gas collecting pockets 10, in order to mix the oil intensively during the rotation of the housing 1. The inert gas (preferably N₂) is supplied via the line 16, and via the latter a desired pressure can also be set; the pressure measuring instrument 13 is used for this purpose. Otherwise, all the parts carrying hot oil are thermally insulated.

In this way, very homogeneous heating of the mold is achieved, as a result of which product defects are largely or completely eliminated.

The right of priority is claimed based on German Patent Application No. 100 47 318.0 , filed Sep. 25, 2000, the disclosure of which is hereby incorporated by reference in its entirety.

The foregoing embodiments have been shown for illustrative purposes only and are not intended to limit the scope of the invention which is defined by the claims.

What is claimed is:

1. A process for producing a plastic part, comprising:
(a) rotating, about a horizontal axis, a housing defining a cavity therein and having a mold affixed in the cavity and a fluid heat exchange medium and a gas contained therein;
(i) to alternately expose to and remove from substantially the entire surface area of a first side of said mold said heat exchange medium as the orientation of said heat exchange medium in said housing changes during said rotating;
(ii) to substantially turbulently mix said heat exchange medium; and
(iii) to heat said mold to the melting temperature of a predetermined plastic material; and
(b) applying a powder of the predetermined plastic material to one side of said mold to form a plastic part.

2. A process for producing a plastic part according to claim 1, further comprising feeding cold heat exchange medium into said housing to cool the plastic part formed on said mold.

3. A process for producing a plastic part according to claim 2, further comprising removing said plastic part from said mold.

4. A process for producing a plastic part according to claim 1, wherein said heat exchange medium comprises a thermally-stable oil.

5. A process for producing a plastic part according to claim 1, wherein said applying comprises applying powder to a second side of said mold opposite said first side of said mold.

6. A process for producing a plastic part according to claim 1, further comprising monitoring a level of said heat exchange medium in said housing.

7. A process for producing a plastic part according to claim 1, further comprising monitoring a pressure of said gas.

8. A process for producing a plastic part according to claim 1, further comprising thermally fusing said plastic powder to form said part and thereafter cooling said part.

9. An apparatus for producing a plastic part comprising:
(a) a housing rotatable about a horizontal axis and defining a cavity therein;
(b) a mold operably linked to said housing and arranged in said cavity such that a first side of said mold faces said cavity and a second side of said mold faces away from said housing;
(c) a liquid heat exchange medium chamber formed within said housing cavity arranged above and in fluid communication with said first side of said mold;
(d) a removable cover for selectively covering said second side of said mold;
(e) a removable box suitable for holding plastic powder in communication with said second side of said mold, said box being interchangeable with said removable cover;
(f) a holder for removably holding said box in communication with said second side of said mold; and
(g) at least one inlet into said chamber for said heat exchange medium and at least one outlet from said chamber for said heat exchange medium.

10. An apparatus for producing a plastic part according to claim 9, wherein said housing further comprises a gas collecting pocket opposite said chamber.

11. An apparatus for producing a plastic part according to claim 9, wherein said chamber further comprises an over pressure valve.

12. An apparatus for producing a plastic part according to claim 9, wherein said housing further comprises a level indicator for monitoring a quantity of heat exchange medium.

13. An apparatus for producing a plastic part according to claim 9, wherein said chamber further comprises a pressure measuring instrument.

14. An apparatus for producing a plastic part according to claim 9, further comprising at least one turbulence generator arranged in said chamber.

15. An apparatus for producing a plastic part according to claim 9, further comprising a feed line and a drain line for cold heat exchange medium connected to said housing.

16. An apparatus for producing a plastic part according to claim 9, further comprising a base on which said housing is rotatably mounted.

17. An apparatus for producing a plastic part according to claim 9, further comprising a drive operably linked to said housing for rotating said housing about a horizontal axis.

18. An apparatus for producing a plastic part according to claim 9, wherein said chamber further comprises a liquid heat exchange medium and a gas blanket over said heat exchange medium.

19. An apparatus for producing a plastic part according to claim 18, wherein said liquid heat exchange medium comprises a thermally-stable oil.

20. An apparatus for producing a plastic part according to claim 14, wherein said at least one turbulence generator comprises a deflection plate.

21. An apparatus for producing a plastic part according to claim 14, wherein said at least one turbulence generator comprises a perforated plate.

22. A molding apparatus, comprising:
(a) a base
(b) a housing rotatably mounted on said base and defining a cavity therein;
(c) a drive operably linked to said housing for rotating said housing about a horizontal axis;
(d) a chamber formed within said housing cavity adapted for containing a liquid heat exchange medium;
(e) a mold mounted in said housing cavity such that a first side of said mold is in fluid communication with said chamber;
(f) a removable box adapted to be selectively placed in communication with a second side of said mold and adapted for containing a plastic powder; and
(g) a holder for removably holding said box on said housing.

23. An apparatus for molding according to claim 22, further comprising a removable cover for cooperating with said holder and selectively covering said second side of said mold.
